(19) United States
(12) Patent Application Publication
(10) Pub. No.: US 2012/0143758 A1
(43) Pub. Date: Jun. 7, 2012

(54) Account Transfer Techniques

(75) Inventors: Anoop Anantha, Kirkland, WA (US); Murali R. Krishnan, Clyde Hill, WA (US); Miller Thomas Abel, Mercer Island, WA (US); Rupali Jain, Redmond, WA (US)

(73) Assignee: MICROSOFT CORPORATION, Redmond, WA (US)

(21) Appl. No.: 12/958,173

(22) Filed: Dec. 1, 2010

(51) Int. Cl. G06Q 40/00

(52) U.S. Cl. 705/44

(57) ABSTRACT

Account transfer techniques are described. In one or more implementations, a user interface is output by a mobile communication device that describes funds in an account. The account is usable by the mobile communication device to purchase goods or service and the purchase performable at least in part using credentials stored in a secure element implemented in hardware of the mobile communication device. An input is received via interaction with the user interface to authorize a transfer of funds from the account associated with the mobile communication device to another account usable by another mobile communication device to purchase goods or services.

### BACKGROUND

Mobile communication devices such as wireless phones have become a common part in the everyday life of a wide variety of users. Indeed, the mobile communications device may serve as a primary point of contact for a variety of business and personal uses. For example, a business user may utilize the mobile communications device to receive email, a casual user may send text messages to friends, and so on.

However, traditional techniques that were employed to securely store data on the mobile communications device as well as to communicate data to the mobile communications device could result in the data being “in the clear.” Even if but for a brief moment in time, malicious parties may take advantage of this to steal sensitive data. This may even result in the ability by the malicious party to access other information on the mobile communications device itself. Consequently, functionality of the mobile communications device may be limited from meeting its true potential due to the ability to compromise the mobile communications device.

### SUMMARY

Account transfer techniques are described. In one or more implementations, a user interface is output by a mobile communication device that describes funds in an account. The account is usable by the mobile communication device to purchase goods or service and the purchase performable at least in part using credentials stored in a secure element implemented in hardware of the mobile communication device. An input is received via interaction with the user interface to authorize a transfer of funds from the account associated with the mobile communication device to another account usable by another mobile communication device to purchase goods or services.

In one or more implementations, a service provider receives a request from a mobile communication device via a network to authorize a transfer of funds from an account associated with the mobile communication device to another account associated with another mobile communication device, in which the accounts are associated to enable respective mobile communication devices to purchase goods or services using credentials that are stored within respective secure elements implemented in hardware by the respective mobile communication devices. The transfer of the funds from the account to the other account is initiated by the service provider.

In one or more implementations, a transfer of funds is authorized through interaction with a user interface output by a mobile communication device from an account associated with the mobile communication device to an account associated with another mobile communication device. The accounts are accessible to purchase goods or services using credentials that are stored within respective secure elements and the secure elements are implemented in tamper-resistant hardware on respective mobile communication devices. A notification is received at the mobile communication device that at least a portion of the funds are to be used to purchase a good or service by the other mobile communication device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in accordance with one or more embodiments of devices, features, and systems for mobile communications.

FIG. 2 depicts a system in an example implementation that is configured to transfer funds between accounts accessible to mobile communication devices.

FIG. 3 is a flow diagram depicting a procedure in an example implementation in which a user interface is output by a mobile communication device that is configured to transfer funds to an account of another mobile communication device.

FIG. 4 is a flow diagram depicting a procedure in an example implementation in which a service provider receives a request to transfer funds from one account to another account, the accounts usable to purchase goods or services by a mobile communication device.

FIG. 5 is a flow diagram depicting a procedure in an example implementation in which notifications are received that relate to funds transferred between accounts associated with mobile communication devices.

FIG. 6 illustrates various components of an example device that can be implemented in various embodiments as any type of a mobile device to implement embodiments of devices, features, and systems for mobile communications.

### DETAILED DESCRIPTION

### Overview

Although traditional mobile communication devices (e.g., mobile phones) were configured to provide a wide variety of functionality to users, this functionality could be limited by an ability of malicious parties and others to compromise data on the mobile communication device. Therefore, although the mobile communication device was generally considered useful by consumers, the functionality that could be employed by the mobile communication device was not able to reach its true potential.

Techniques are described herein in which data may be securely provisioned and stored by a mobile communication device. These techniques may be leveraged for a variety of purposes. For example, the mobile communication device may be configured to include a secure element that is implemented in hardware to be resistant to tampering and “snooping.” Therefore, data may be stored within the secure element that has a decreased likelihood of being discovered, which may serve to support a wide variety of functionality.

One example of this functionality is an ability to store credentials that are usable to purchase goods or services. For example, the secure element may be configured to answer challenges, provide account information, and so on and thus function as an “eWallet.” In this way, a user may utilize the mobile communication device in much the same way as a traditional credit card to purchases goods or services of interest.

The secure element may also support a wide range of additional functionality. For example, the mobile communication device may be configured to interact with other mobile communication devices to transfer funds. For instance, a father may interact with a mobile communication device to transfer funds to an account associated with a daughter's mobile communication device, such as by “tapping” the devices together to cause transfer of credentials between the devices. These credentials may then serve as a basis to transfer funds to the daughter's account, such as to interact with a “cloud” service that manages the accounts. A wide variety of other techniques and examples are contemplated, further discussion of which may be found in relation to the following sections.

In the following discussion, a variety of example implementations of a mobile communications device (e.g., a wireless phone) are described. Additionally, a variety of different functionality that may be employed by the mobile communications device is described for each example, which may be implemented in that example as well as in other described examples. Accordingly, example implementations are illustrated of a few of a variety of contemplated implementations. Further, although a mobile communications device having one or more modules that are configured to provide telephonic functionality are described, a variety of other mobile devices are also contemplated, such as personal digital assistants, tablet computers, mobile music players, dedicated messaging devices, portable game devices, netbooks, and so on.

Example Implementations

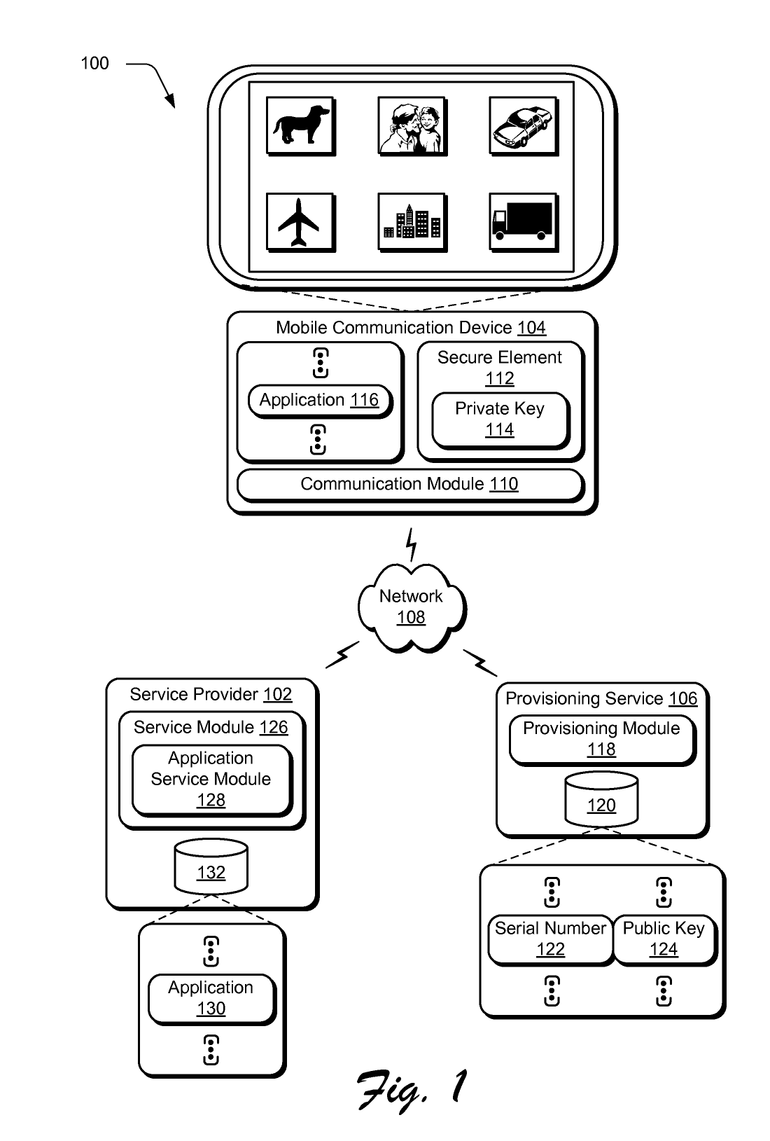

FIG. 1 is an illustration of an example implementation of an environment 100 that is operable to employ the techniques described herein. The environment includes a service provider 102, a mobile communications device 104, and a provisioning service 106 that are illustrated as communicatively coupled, one to another, via a network 108. Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be representative of multiple networks.

The mobile communications device 102 is further illustrated as including a communication module 110. The communication module 110 is representative of functionality of the mobile communications device 102 to communicate via the network 108. For example, the communication module 110 may include telephone functionality to make and receive telephone calls, such as by employing a telephone module to communicate via a plain old telephone service (POTS), wireless network (e.g., cellular and/or Wi-Fi), and so on.

The communication module 110 may also include a variety of other functionality, such as to capture content, form short message service (SMS) text messages, multimedia messaging service (MMS) messages, emails, status updates to be communicated via a social network service or micro-blog, and so on. For instance, the communication module 110 may also support browser functionality to browse the network 108.

The mobile communications device 104 is further illustrated as including a secure element 112. In one or more implementations, the secure element 112 is representative of functionality to support secure communications with the mobile communications device 104. For example, the secure element 112 may be implemented using hardware and configured during manufacture to include a private key 114. For instance, the secure element 112 may be implemented using a tamper-resistant integrated circuit that are resistant to “snooping” as well as physical removal from the mobile communications device 104 by a manufacturer of the device, e.g., by covering a surface-mounted integrated circuit with an epoxy that helps to prevent snooping of the circuit as well as causing the circuit to break if removal is attempted.

In implementations, the secure element 112 includes functionality to perform encryption and/or decryption operations. For example, the secure element 112 may use the private key 114 to perform a decryption operation and expose a result of the operations to other functionality of the mobile communication device 104, such as to one or more applications 116 that are executable by the mobile communications device 104. In this example, the secure element 112 may receive data to be decrypted from the application 116, decrypt the data using the private key 114, and then expose a result of the decryption operation (i.e., the decrypted data) to the application 116. Therefore, inclusion of the private key 114 in the secure element 112 may help to protect the private key 114 from discovery “outside” the secure element 112 by keeping the private key 114 from being exposed “in the clear” during the decryption operation.

A variety of other functionality may also be supported through use of the secure element 112. For example, the secure element 112 may support a protected communication channel through the provisioning service 106. The provisioning service 106, for instance, may include a provisioning module 118 and storage 120. The storage 120 may be used to maintain a serial number 122 assigned to an integrated circuit that includes the secure element 112 and a corresponding public key 124 that forms an asymmetric public/private key pair with the private key 114 of the mobile communications device 104. The provisioning module 118 may thus provide the public key 124 to third-party services such that communication between the third-party service and the mobile communications device 104 is protected, even if that communication occurs using the provisioning service 106 or other service as an intermediary.

For example, a user of the mobile communications device 104 may interact with the communication module 110 or other functionality (e.g., an application 116) to navigate to a service provider 102 over the network 108. The service provider 102 as illustrated includes a service module 126 that is representative of functionality to provide one or more services for access via the network 108.

An example of one of these services is illustrated as an application service module 128. The application service module 128 is representative of functionality to manage dissemination of one or more applications 130 via the network 108. Although the applications 130 are illustrated as stored in storage 132 local to the service provider 102 (e.g., as part of a server farm that implements the service provider 102), the storage 132 may be representative of a wide variety of different types of storage, e.g., third party storage.

In an example, the application service module 138 manages a marketplace configured to provide applications 130 for purchase via the network 108. Therefore, a user of the mobile communication device 104 may access the marketplace to purchase one or more of the applications 130 for download to local storage, which is illustrated as application 116 in this example. To purchase and/or transport the application 130, the mobile communications device 104 and the service provider 102 may utilize secure communications implemented at least in part through use of the secure element 112. The secure communications may be implemented in a variety of ways.

In one instance, the public key 124 is provided to secure communications between the service provider 102 and the mobile communications device 104 directly. For example, the public key 124 may be located by the provisioning module 118 of the provisioning service 106 by obtaining a serial number 122 for the integrated circuit that implements the secure element 112, e.g., from the mobile communications device 104. The provisioning module 118 may then use the serial number 122 to locate the public key 124 and provide the public key 124 to the service provider 102. The public key 124 may then be used to encrypt data to be communicated to the mobile communications device 104, such as the application 130, billing information and other credentials, and so on.

In another instance, the provisioning service 106 provides the public key 124 to the service provider 102 as a basis to support indirect communications, such as to securely transport credentials and other data (e.g., cryptographic keys) that are to be used as a basis to form a communication channel. For example, the service provider 102 may provide credentials (e.g., other cryptographic keys) that are to be used to secure communications between the service provider 102 and the mobile communications device 104. To protect these credentials from compromise by malicious parties, the credentials may be encoded using this public key 124. In other words, the other cryptographic keys may be encrypted using the public key 124 for communication to the mobile communications device 104 to protect the other cryptographic keys from discovery by malicious parties.

In this way, regardless of whether the communication is communicated indirectly via the provisioning service 106 or directly via the network 108, the credentials (e.g., the other cryptographic keys) are protected from discovery through encryption using the public key 124. Therefore, even the provisioning service 106 itself is not able to determine “what” is being communicated between the service provider 102 and the mobile communications device 104.

The mobile communications device 104 may then decrypt the communication using the secure element 112, and more particularly the private key 114, to obtain the other cryptographic keys. A variety of different techniques may then be employed to utilize the other cryptographic keys once decrypted.

In one technique, the other cryptographic keys are exposed for use outside the secure element 112, such as by an application 116 or other functionality of the mobile communications device 104. Thus, in this techniques the secure element 112 is leveraged to provide the credentials that are used to serve as a basis to secure communications but is not used to secure the communications itself, i.e., to provide the actual encryption/decryption.

In another technique, the other cryptographic keys may be kept from being exposed outside the secure element 112 through storage within the secure element 112. The secure element 112 may then use the cryptographic keys as previously described to decrypt and/or encrypt data received by the secure element 112 without exposing the cryptographic keys “outside” the secure element 112. The secure element 112 may thus employ a variety of different techniques to secure communications with the mobile communications device 104, the example of the service provider 102 above being but one of many such examples.

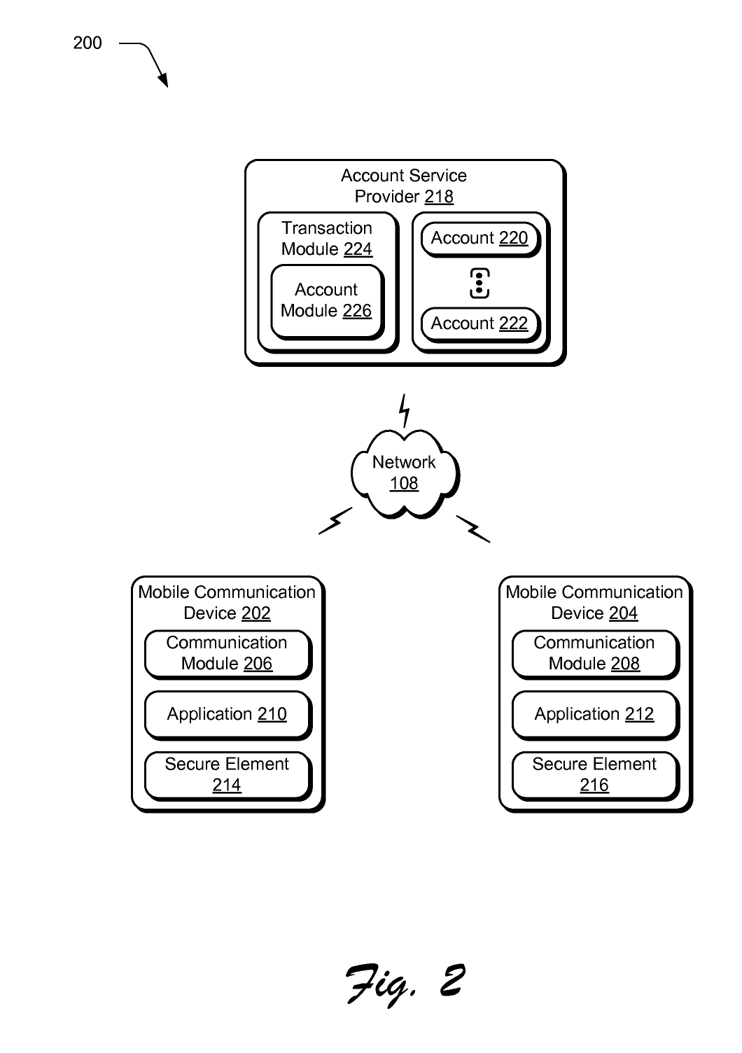

Thus, the secure element 112 may be leveraged to provide a variety of different functionality. For example, the secure element 112 may be utilized to makes purchases of goods or services using credentials that have been securely provisioned therein. The communication module 110, for instance, may include functionality to communicate using near field technology (NFT) with a merchant to purchase a good or service, such as by “tapping” the mobile communication device 104 against a NFT reader of the merchant. Credentials may then be communicated between the mobile communication device 104 and the merchant to perform the purchase, such as credentials similar to those found on a credit card. Other examples are also contemplated, such as indirect communication to make a purchase, such as to communicate via a network 108 with a service provider that performs the transaction using information objected form the mobile communication device 104 and the merchant, further discussion of which may be found in relation to FIG. 2.

Generally, any of the functions described herein can be implemented using software, firmware, hardware (e.g., fixed logic circuitry), or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

The instructions can be stored in one or more computer-readable media. As described above, one such configuration of a computer-readable medium is signal bearing medium and thus is configured to transmit the instructions (e.g., as a carrier wave) to the hardware of the computing device, such as via the network 104. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. The features of the techniques described below are platform-independent, meaning that the techniques may be implemented on a variety of commercial computing platforms having a variety of hardware configurations.

FIG. 2 depicts a system 200 in an example implementation that is configured to transfer funds between accounts access to mobile communication devices. The system 200 includes first and second mobile communication devices 202, 204. The first and second mobile communication devices 202, 204 may or may not correspond to the mobile communication device 104 of FIG. 2. The mobile communication devices 202, 204 as illustrated include respective communication modules 206, 208, applications 210, 212, and secure elements 214, 216.

The applications 210, 212, for instance, may be obtained from an application marketplace implemented by the application service module 128 of the service provider 102 as described in relation to FIG. 1. In this example, the applications 210, 212 correspond to an account service provider 218 that is configured to manage accounts 220, 220 that are usable in conjunction with the secure elements 214, 216 to purchase goods or services. The account service provider 218 may be part of a financial institution, e.g., bank, credit union, credit card company, and so on.

The account service provider 218, for instance, may utilize a transaction module 224 that is representative of functionality to perform transactions, e.g., purchases. Part of this functionality may include managing the accounts 220, 222, which is represented by an account module 226. The account module 226, for instance, may manage deposits to and withdrawals from the accounts 220, 222, transfer of funds between accounts 220, 222, and so on.

A user of the first mobile communication device 202, for instance, may be related to a user of the second mobile communication device 204, e.g., father/daughter, and wish to transfer funds from his account 220 to his daughter's account 222. Accordingly, the user of the mobile communication device 202 may launch the application 210, such as by selecting an icon and entering a PIN.

In another example, the mobile communication devices 202, 204 may be “tapped” together to initiate a fund transfer by identifying the devices. The tap, for instance, may cause respective applications 210, 212 to communicate a time, location, and/or a unique identifier such that the account service provider 218 may determine which mobile communication devices 202, 204 are involved.

The application 210 may then interact with the account service provider 218 to obtain data that describes the account 220, e.g., an account balance, recent transactions, and so on. In an implementation, this access is granted at least in part using the secure element 214 of the mobile communication device 202, such as to provide credentials, answer a challenge by the account service provider 218, form a secure communication channel between the account service provider 218 and the mobile communication device 202, and so on.

The application 210 may then cause output of a user interface via which the user may access their account 220, which may include an option to transfer funds to another account. The user of the mobile communication device 202, for instance, may identify the account 222 (e.g., by entering an account number, the “tap” as previously described) and an amount of funds to be transferred to the account 222. Information describing this transfer may then be communicated “up” to the account service provider 218, and more particularly the account module 226, to perform the transfer of funds from the father's account 220 to the daughter's account 222.

This information may also be communicated to the daughter's mobile communication device 204. The communication may also be performed using the secure element 216 of the daughter's mobile communication device 204, such as to provide credentials, answer a challenge by the account service provider 218, form a secure communication channel between the account service provider 218 and the mobile communication device 202, and so on. For example, the account service provider 218 may provision credentials in the secure element 216 of the mobile communication 204 using the techniques described in relation to FIG. 1 to enable the mobile communication device 204 to be used to purchase goods or services. Although this transfer of funds was described as involving indirect communication between the mobile communication devices 202, 204 using the account service provider 218, a variety of other examples are also contemplated.

For example, a “tap” may be performed as previously described, which may cause each of the applications 210, 212 to be launched. A user interface output by the mobile communication device 202 may then provide an option to specify an amount of funds to transfer to the other mobile communication device 204. Once specified, the mobile communication devices 202, 204 may communicate using NFT to transfer credentials from the secure element 214 of the mobile communication device 202 to the secure element 216 of the other mobile communication device. These credentials may be used in a variety of ways, such as to enable the mobile communication device 204 to purchase goods or services before interacting with the account service provider 218, to transfer funds between the accounts 220, 222 which are then usable in conjunction with the mobile communication device 204 to purchase goods or services, and so on.

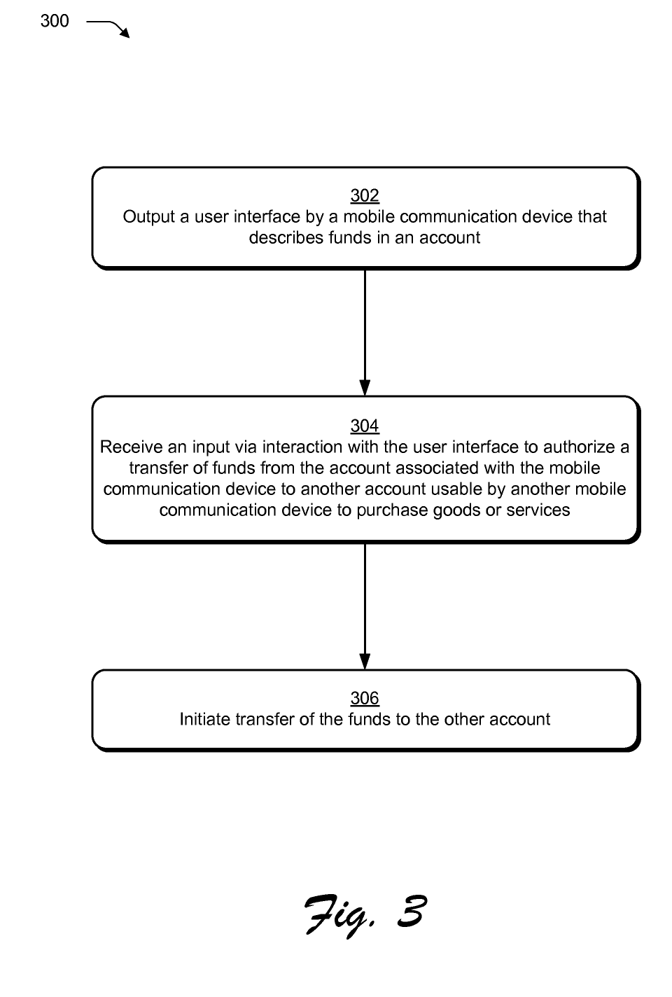

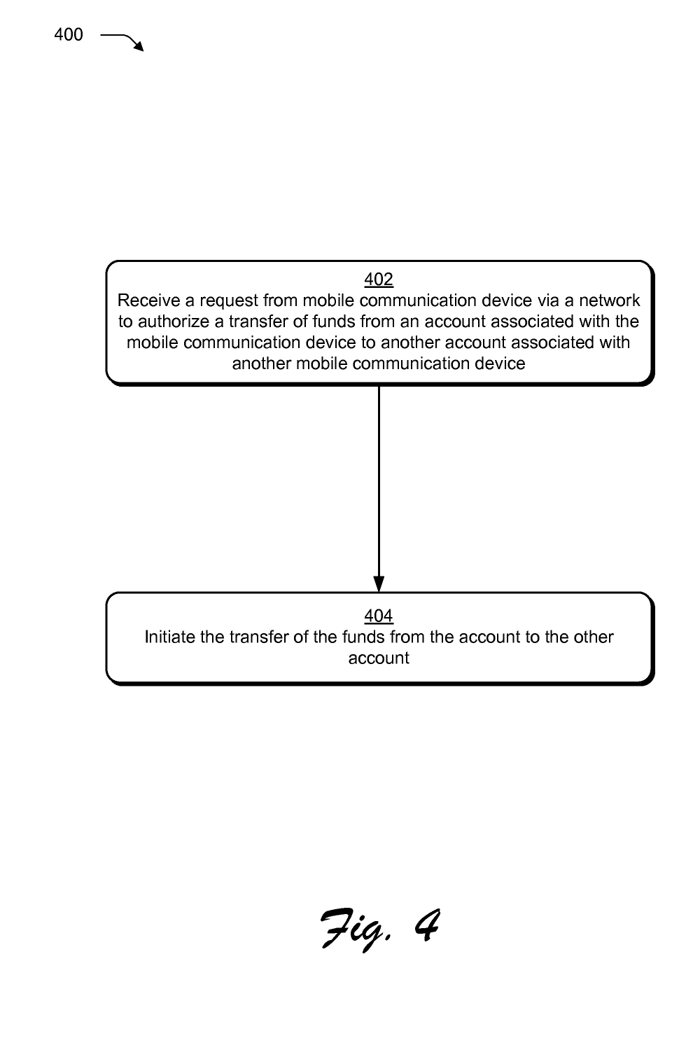

Although the example system 200 described a one-to-one transfer, a variety of different fund transfers are contemplated. For example, these techniques may be leveraged to “chain” transfers of funds, e.g., from father to daughter to friends. In another example, a “one to many” transfer may be performed, such as from the father to multiple children. Thus, the secure elements 214, 216 of the mobile communication devices may support a wide variety of techniques to transfer funds, further discussion of which may be found in relation to FIGS. 3 and 4.

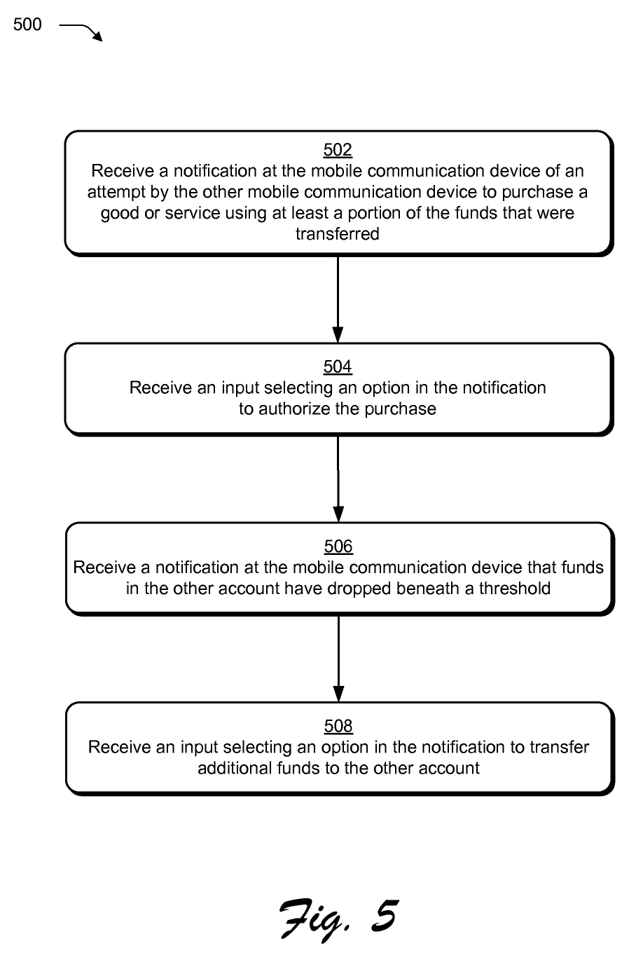

These techniques may also support a wide range of other functionality. For example, notifications may be utilized to authorize use of the funds, describe when an account balance has dropped below a threshold amount, and so on. In another example, the notifications may be provided in the form of a report that may be communicated to the mobile communication device that transferred the funds, mobile communication devices that received the funds, visited using a portal, and so on. Thus, the notifications may be used to help “share” account information when desired, further discussion of which may be found in relation to FIG. 5.

Example Procedures

The following discussion describes account transfer techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 and systems 200 of FIGS. 1 and 2, respectively.

FIG. 3 depicts a procedure 300 in an example implementation in which a user interface is output by a mobile communication device that is configured to transfer funds to an account of another mobile communication device. A user interface is output by a mobile communication device that describes funds in an account (block 302). The user interface may be output in response to a variety of different factors, such as selection of an application 210 and entry of a PIN, “tapping” the mobile communication device 202 with another mobile communication device 204, in response to a communication received from the account service provider 218, and so on.

An input is received via interaction with the user interface to authorize a transfer of funds from the account associated with the mobile communication device to another account usable by another mobile communication device to purchase goods or services (block 304). The user interface, for instance, may include an option to enter an amount of funds to be transferred to the account 222 of the other mobile communication device 204. The identification of the account 2222 may also be performed in a variety of ways, such as to manually enter an account number, the “tap” of the devices as previously described, and so on. For instance, the “tap” may cause each of the mobile communication devices to communicate a time the tap was registered, a location at which the tap was registered, and/or a unique identifier of the devices. The account service provider 218 may then use this information to determine which accounts 220, 220 are involve in the transfer.

Transfer of the funds to the other account is initiated (block 306). A user, for example, may select an option in the user interface to initiate the transaction, which may cause a communication to be formed and communicated to the account service provider 218 to perform the transfer, further discussion of which may be found in relation to the following figure.

FIG. 4 depicts a procedure 400 in an example implementation in which a service provider receives a request to transfer funds from one account to another account, the accounts usable to purchase goods or services by a mobile communication device. A request is received from a mobile communication device via a network to authorize a transfer of funds from an account associated with the mobile communication device to another account associated with another mobile communication device (block 402). Continuing with the previous example, the request may be received for a variety of different actions performed by the mobile communication devices 202, 204, such as “tapping” together, selecting an option that is output in a display of a user interface, and so on.

The transfer of the funds from the account to the other account is initiated (block 404). The account module 226 of the account service provider 218, for instance, may determine that the credentials of the mobile communication device 202 have been verified and then permit the transfer of funds from the account 220 to the other account 222. The transfer may involve a variety of different techniques, such as to transfer funds at the account service provider 218 between the accounts and/or to communicate credentials “down” to the mobile communication device 204 that may be stored using the secure element 216 to make purchases, and so on. Further, notification techniques may also be employed to help manage usage of these funds, further discussion of which may be found in relation to the following figure.

FIG. 5 depicts a procedure 500 in an example implementation in which notifications are received that relate to funds transferred between accounts associated with mobile communication devices. A notification is received at the mobile communication device of an attempt by the other mobile communication device to purchase a good or service using at least a portion of the funds that were transferred (block 502). A user of the mobile communication device 204, for instance, may communicate credentials to a merchant through use of the secure element 216 that are usable to purchase a good or service from the account 222. Further, the account service provider 218 may determine that these funds were transferred to the account 222 from another account 220. Accordingly, the mobile communication device 204 and/or the account service provider 218 may communicate the notification to the mobile communication device 202 that the purchase is being attempted.

An input is received selecting an option in the notification to authorize the purchase (block 504). Continuing with the previous example, the notification may include an option (e.g., either directly in the notification and/or indirectly through a link) such that a user of the mobile communication device 202 that transferred the funds may authorize usage of the funds. In this way, a degree of control may be exercised over how the funds that were transferred from the account 220 of a user of the mobile communication device 202 are used. Other notifications are also contemplated.

For example, a notification is received at the mobile communication device that funds in the other account have dropped beneath a threshold (block 506). Like before, this notification may originate by the mobile communication device 204 that is configured to utilize the funds, an account service provider 218 that manages the account 222, and so on.

An input is received selecting an option in the notification to transfer additional funds to the other account (block 508). This transfer may be performed in a variety of ways as previously described in relation to FIGS. 3 and 4. Thus, a user of the mobile communication device 202 in this example, may be made aware as to a status of funds used by a user of another mobile communication device 204 and may replenish those funds as desired. A variety of other notifications are also contemplated without departing from the spirit and scope thereof.

Example Device

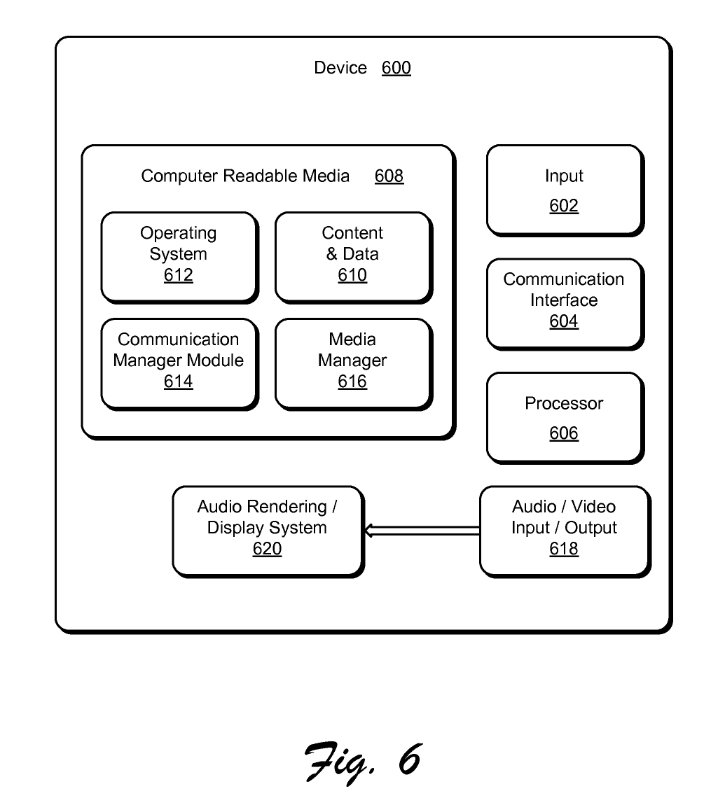

FIG. 6 illustrates various components of an example device 600 that can be implemented in various embodiments as any type of a mobile device to implement embodiments of devices, features, and systems for mobile communications. For example, device 600 can be implemented as any of the mobile communications devices described previously. Device 600 can also be implemented to access a network-based service, such as a social network service as previously described.

Device 600 includes input 602 that may include Internet Protocol (IP) inputs as well as other input devices, such as the keyboard 112 of FIG. 1. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface enables device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.).

Computer-readable media 608 provides data storage to store content and data 610, as well as device applications and any other types of information and/or data related to operational aspects of device 600. For example, an operating system 612 can be maintained as a computer application with the computer-readable media 608 and executed on processor 606. Device applications can also include a communication manager module 614 (which may be used to provide telephonic functionality) and a media manager 616.

Device 600 also includes an audio and/or video output 618 that provides audio and/or video data to an audio rendering and/or display system 620. The audio rendering and/or display system 620 can be implemented as integrated component(s) of the example device 600, and can include any components that process, display, and/or otherwise render audio, video, and image data. Device 600 can also be implemented to provide a user tactile feedback, such as vibrate and haptics.

Generally, any of the blocks can be implemented using software, firmware, hardware (e.g., fixed logic circuitry), or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
outputting a user interface by a mobile communication device that describes funds in an account, the account usable by the mobile communication device to purchase goods or services, the purchase performable at least in part using credentials stored in a secure element implemented in hardware of the mobile communication device; and
receiving an input via interaction with the user interface to authorize a transfer of funds from the account associated with the mobile communication device to another said account usable by another said mobile communication device to purchase goods or services.

2. A method as described in claim 1, wherein the user interface describes an account balance and is configured to receive one or more inputs to select the other said account.

3. A method as described in claim 1, wherein the user interface is output by an application executed on the mobile communication device, the application authorized by an account service provider to access the account and downloaded by the mobile communication device via an Internet.

4. A method as described in claim 1, further comprising responsive to the receiving, initiating the transfer of the funds from the account to the other said account.

5. A method as described in claim 4, wherein the transfer includes communicating a credential from the secure element of the mobile communication device to a secure element of the other said mobile communication device.

6. A method as described in claim 4, wherein the transfer includes communicating with an account service provider that maintains the account and the other said account, the account service provider being accessible to the mobile communication device and the other said mobile communication device via an Internet.

7. A method as described in claim 1, further comprising receiving a notification at the mobile communication device of an attempt by the other said mobile communication device to purchase a good or service using at least a portion of the funds that were transferred.

8. A method as described in claim 7, wherein the notification includes an option to authorize the purchase.

9. A method as described in claim 1, further comprising receiving a notification at the mobile communication device that a balance of funds in the other said account is below a threshold.

10. A method as described in claim 1, further comprising receiving a report by the mobile communication device by visiting a portal, the report describing the account or the other said account.

11. A method as described in claim 1, wherein the user interface is configured to perform a chained fund transfer or a one to many fund transfer.

12. A method implemented by one or more computing devices of a service provider, the method comprising:
receiving a request from mobile communication device via a network to authorize a transfer of funds from an account associated with the mobile communication device to another account associated with another mobile communication device, in which the accounts are associated to enable respective said mobile communication devices to purchase goods or services using credentials that are stored within respective secure elements implemented in hardware by the respective said mobile communication devices; and
initiating the transfer of the funds from the account to the other account.

13. A method as described in claim 12, further comprising forming a notification to the communicated to the mobile communication device that the other mobile communication device has used at least a portion of the funds to purchase a good or service.

14. A method as described in claim 12, further comprising forming a notification to the communicated to the mobile communication device that the other mobile communication device to authorize use of at least a portion of the funds to purchase a good or service.

15. A method as described in claim 12, further comprising receiving a notification at the mobile communication device that a balance of funds in the other account is below a threshold.

16. A method comprising:
authorizing a transfer of funds through interaction with a user interface output by a mobile communication device from an account associated with the mobile communication device to an account associated with another mobile communication device in which:
the accounts are accessible to purchase goods or services using credentials that are stored within respective secure elements; and
the secure elements are implemented in tamper-resistant hardware on respective said mobile communication devices; and
receiving a notification at the mobile communication device that at least a portion of the funds are to be used to purchase a good or service by the other mobile communication device.

17. A method as described in claim 16, wherein the notification includes an option to authorize the purchase.

18. A method as described in claim 16, wherein the notification describes the purchase that was made using the portion of the funds that were transferred.

19. A method as described in claim 16, further comprising receiving a notification at the mobile communication device that a balance of funds in the other account is below a threshold.

20. A method as described in claim 19, wherein the notification at the mobile communication device that the balance of funds in the other account is below the threshold includes an option to transfer additional funds to the other account from the account.
